(19) United States
(12) Patent Application Publication
(10) Pub. No.: US 2025/0372824 A1
(43) Pub. Date: Dec. 4, 2025

(54) BUSBAR MODULE

(71) Applicant: Yazaki Corporation, Tokyo (JP)

(72) Inventor: Makoto Ogawa, Makinohara-shi (JP)

(21) Appl. No.: 19/200,226

(22) Filed: May 6, 2025

(30) Foreign Application Priority Data
May 29, 2024 (JP) 2024-087152

(51) Int. Cl. H01M 50/503; H01M 50/204; H01M 50/507; H01M 50/519

(52) U.S. Cl. CPC H01M 50/503; H01M 50/507; H01M 50/519; H01M 50/204

(57) ABSTRACT

A busbar module includes a circuit body formed of a flexible substrate, and busbars respectively connected to electrodes of a plurality of single cells. The circuit body includes a main line arranged to extend along a stacking direction of the plurality of single cells, a branch line branched from the main line and to extend toward the busbar, the branch line having a portion extending along the stacking direction as at least a part of the branch line, and a terminal portion provided at a location of the branch line which is closer to a distal end side than the portion, and to be attached to the busbar. The branch line has a shape in which at least a part of the branch line is folded back toward the main line to overlap the main line in a thickness direction of the main line.

### CROSS-REFERENCE TO RELATED APPLICATIONS

This application is based on and claims priority under 35 USC 119 from Japanese Patent Application No. 2024-087152 filed on May 29, 2024, the entire content of which is incorporated herein by reference.

### TECHNICAL FIELD

The present disclosure relates to a busbar module.

### BACKGROUND ART

In the related art, a busbar module is used, for example, to be assembled to a battery assembly (a battery module in which a plurality of battery cells are stacked and arranged) that is used as a driving power source mounted on an electric vehicle, a hybrid vehicle, or the like.

For example, the busbar module in the related art includes a plurality of busbars and voltage detection lines. Each of the busbars connects a positive electrode and a negative electrode between adjacent battery cells that are stacked. The voltage detection lines are respectively connected to the plurality of busbars. The voltage detection line is configured to bundle a plurality of electric wires. Each of the electric wires has a general structure in which a core wire is covered with an insulating sheath as disclosed in, for example, JP2014-220128A.

In general, the battery cells constituting the battery assembly expand and contract in a stacking direction due to operating heat associated with charging and discharging, a temperature of an external environment, and the like. As a result, the battery assembly also deforms to expand and contract in the stacking direction of the battery cells. Further, a size of the battery assembly in the stacking direction may generally vary for each manufactured battery assembly (that is, a manufacturing variation may occur) due to an assembly tolerance when the plurality of battery cells are stacked and arranged. Therefore, the busbar module is generally designed to have a certain margin in a length of the voltage detection line in order to cope with such deformation and manufacturing variation of the battery assembly.

However, in the busbar module in the related art described above, for example, when the number of the stacked battery cells is increased for a purpose of increasing a capacity of the battery assembly, the number of the electric wires constituting the voltage detection line also increases. As a result, when the voltage detection line is formed by bundling these many electric wires, a rigidity of the voltage detection line as a whole (and thus a rigidity of the busbar module) increases, and the busbar module may be difficult to expand and contract to sufficiently cope with the deformation and the manufacturing variation of the battery assembly.

The present disclosure provides a busbar module excellent in adaptability to deformation and manufacturing variation of a battery assembly.

### SUMMARY OF INVENTION

In order to achieve the object described above, a busbar module according to the present disclosure is characterized as follows.

A busbar module to be attached to a battery assembly in which a plurality of single cells are stacked, the busbar module includes a circuit body formed of a flexible substrate in which a wiring pattern is provided, and busbars configured to be respectively connected to electrodes of the plurality of single cells. The circuit body includes a main line configured to be arranged to extend along a stacking direction of the plurality of single cells, a branch line configured to be branched from the main line and to extend toward the busbar, the branch line having a portion extending along the stacking direction as at least a part of the branch line, and a terminal portion configured to be provided at a location of the branch line which is closer to a distal end side than the portion, and to be attached to the busbar. The branch line has a shape in which at least a part of the branch line is folded back toward the main line to overlap the main line in a thickness direction of the main line.

According to the busbar module according to the present disclosure, the circuit body formed of the flexible substrate includes the main line and the branch line branching from the main line. At least a part of the branch line has the portion (absorption portion described later) extending along the stacking direction of the single cells. The branch line has the shape in which at least a part of the branch line is folded back toward the main line to overlap the main line in the thickness direction of the main line. Therefore, when the battery assembly expands and contracts in the stacking direction due to thermal deformation of each single cell, the busbar can move in the stacking direction of the single cells by deforming the branch line around the absorption portion of the branch line of the circuit body and a periphery of the absorption portion. Similarly, the variation in the size of the battery assembly in the stacking direction which occurs due to the assembly tolerance of the single cells can be absorbed. In other words, in the busbar module having the configuration, the main line of the circuit body does not need to be deformed at all, and it is possible to easily cope with the expansion and contraction and the manufacturing variation of the battery assembly by substantially deforming only the branch line. Since the branch line has the shape in which the branch line is folded back toward the main line to overlap the main line in the thickness direction of the main line, a size of the circuit body in the width direction can be reduced as compared with a case in which the branch line simply extends from the main line. In general, even when the flexible substrate includes a large number of circuit structures, the flexible substrate is easily and flexibly deformed using a much smaller force as compared with an electric wire used in the busbar module in the related art described above. Therefore, the busbar module according to the present disclosure has excellent adaptability to the deformation and the manufacturing variation of the battery assembly.

The present disclosure has been briefly described above. Further, details of the present disclosure will be further clarified by reading modes for carrying out the disclosure described below with reference to the accompanying drawings.

### BRIEF DESCRIPTION OF DRAWINGS

FIG. 1 is a perspective view showing a circuit body and a busbar constituting a busbar module according to the present embodiment, and a battery assembly to which the busbar module is to be attached;

FIG. 2 is a top view showing a state before a branch line is folded back in the circuit body shown in FIG. 1;

FIG. 3 is a top view showing a state in which the branch line is folded back in the circuit body shown in FIG. 2;

FIG. 4 is a top view showing a state before a branch line is folded back in a circuit body according to a first modification;

FIG. 5 is a top view showing a state in which the branch line is folded back in the circuit body shown in FIG. 4;

FIG. 6 is a top view showing a state in which a branch line is folded back in a circuit body according to a second modification; and

FIG. 7 is a top view showing a state in which a branch line is folded back in a circuit body according to a third modification.

### DESCRIPTION OF EMBODIMENTS

### Embodiment

Hereinafter, a busbar module 10 according to an embodiment of the present disclosure will be described with reference to the drawings. The busbar module 10 according to the present embodiment is used, for example, to be assembled to a battery assembly (a battery module in which a plurality of single cells are stacked and arranged) that is used as a driving power source mounted on an electric vehicle, a hybrid vehicle, or the like.

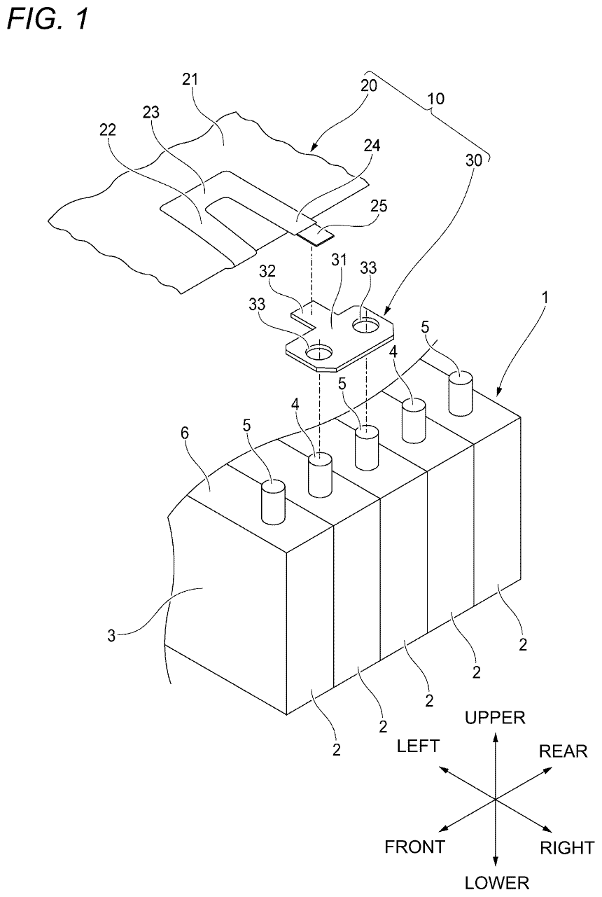

Hereinafter, for convenience of description, “front”, “rear”, “upper”, “lower”, “left”, “right”, a “front-rear direction”, an “upper-lower direction”, and a “left-right direction” are defined as shown in FIG. 1. The “front-rear direction”, the “upper-lower direction”, and the “left-right direction” are orthogonal to one another. The front-rear direction coincides with a “stacking direction of the plurality of single cells” in the present disclosure. The upper-lower direction coincides with a “thickness direction of a main line” in the present disclosure.

First, a battery assembly 1 to which the busbar module 10 according to the present embodiment is to be attached will be described. As shown in FIG. 1, the battery assembly 1 is formed by connecting a plurality of single cells 2 in series. Each of the plurality of single cells 2 is provided with a positive electrode 4 or a negative electrode 5 protruding from an upper portion of a battery body (body) 3 that is formed in a rectangular parallelepiped shape. The positive electrode 4 and the negative electrode 5 are arranged apart from each other on an electrode surface 6 of the battery body 3, and are provided to protrude in a columnar shape substantially vertically upward from the electrode surface 6.

In the battery assembly 1, the single cells 2 are arranged to be stacked in the front-rear direction (stacking direction) such that the positive electrode 4 and the negative electrode 5 of the adjacent single cells 2 are alternately arranged. In the battery assembly 1, for example, among the single cells 2 corresponding to both ends of the single cells 2 connected in series, the positive electrode 4 of one single cell 2 is a total positive electrode, and the negative electrode 5 of the other single cell 2 is a total negative electrode.

Next, the busbar module 10 according to the present embodiment will be described. As shown in FIG. 1, the busbar module 10 includes a circuit body 20 and busbars 30. The circuit body 20 is formed of a flexible substrate (so-called FPC). Each of the busbars 30 is connected to the positive electrode 4 and the negative electrode 5 between two of the plurality of single cells 2. The busbar module 10 may include a holder (not shown) that accommodates and holds the circuit body 20, that is to be attached to the battery assembly 1, and that is made of a resin.

As shown in FIG. 1, the circuit body 20 is arranged on the single cells 2 along the stacking direction, and includes a strip-shaped main line 21 in which a plurality of wiring patterns are provided. A connector (not shown) is attached to an end of the main line 21 in a longitudinal direction (the front-rear direction, which substantially coincides with the “stacking direction” of the battery assembly 1 in this example) via a voltage detection line (not shown) drawn from the main line 21. The connector can be connected to a voltage detector (not shown).

Strip-shaped branch lines 22 extend from a plurality of locations of a side end along the longitudinal direction of the main line 21. In FIG. 1, one of the plurality of branch lines 22 extending from the plurality of locations is representatively shown. The main line 21 and the branch lines 22 are formed of the FPC. Therefore, the main line 21 and the branch lines 22 can be flexibly deformed particularly in a direction orthogonal to each surface.

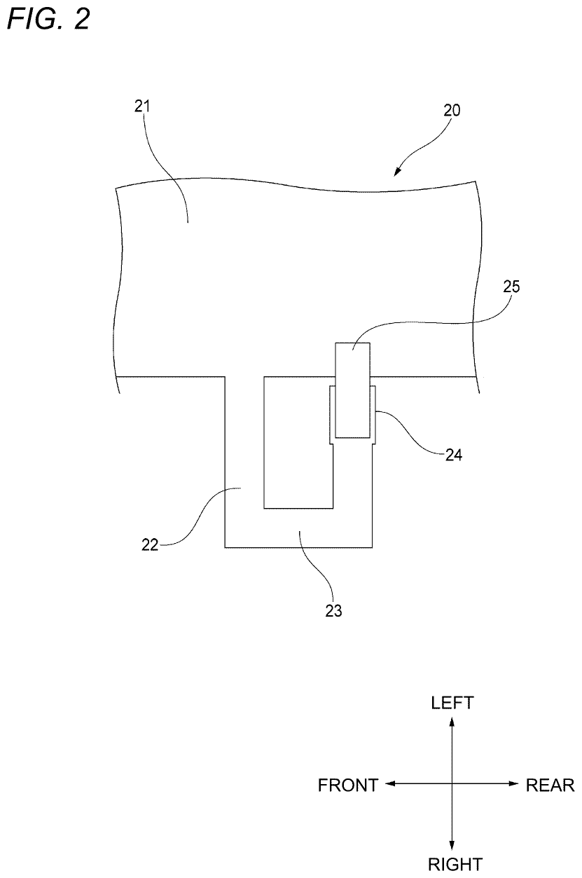

As shown in FIG. 2, before being folded back as described later, the branch line 22 extends from the side end of the main line 21 in an area that is outside the side end of the main line 21 in a width direction (left-right direction) while being bent so as to have a substantially U-shape that opens toward the main line 21 when viewed from the upper-lower direction. The branch line 22 includes an absorption portion 23 that is a portion extending in the longitudinal direction of the main line 21 (that is, the stacking direction of the battery assembly 1). Therefore, a distal end 24 of the branch line 22 can move relative to the main line 21 in the longitudinal direction of the main line 21 (that is, the stacking direction of the battery assembly 1) by deforming the branch line 22 around the absorption portion 23 and a periphery thereof. A terminal portion 25 made of a metal is connected to the distal end 24 (a location closer to a distal end side than the absorption portion 23) of the branch line 22. In the present embodiment, the terminal portion 25 is a flat plate-shaped rectangular metal plate. The terminal portion 25 is electrically connected to the voltage detection line drawn from the main line 21 via a wiring pattern in the branch line 22 and the wiring pattern in the main line 21. In this example, one absorption portion 23 is provided in the branch line 22.

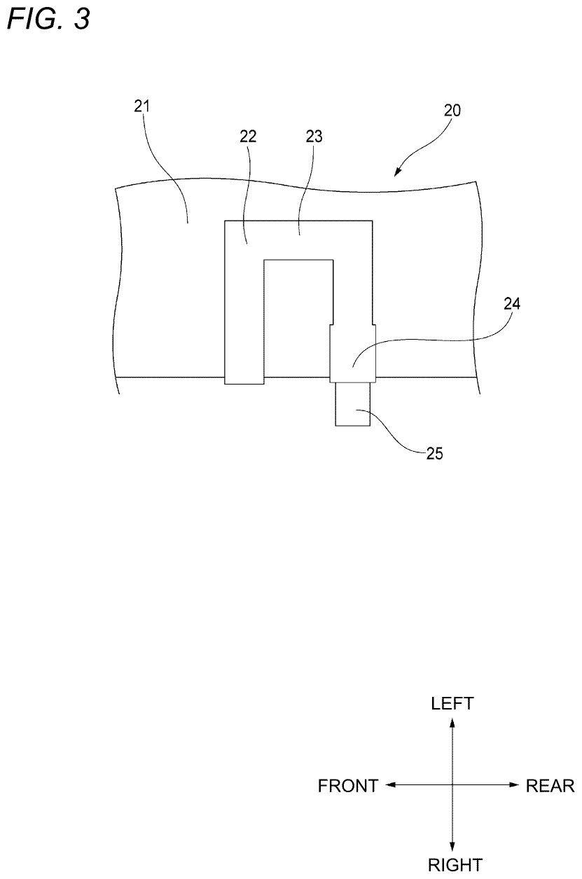

In the present embodiment, as shown in FIGS. 1 and 3, the branch line 22 shown in FIG. 2 is folded back to a front side (upper side) of the main line 21 toward the main line 21 such that substantially the entire branch line 22 overlaps the main line 21 in the thickness direction (upper-lower direction) of the main line 21 (such that substantially the entire branch line 22 is located within an area occupied by the main line 21 when viewed from the upper-lower direction). As a result, the terminal portion 25 is arranged to protrude outward in the width direction (left-right direction) from the side end of the main line 21.

As shown in FIG. 1, the busbar 30 integrally includes a busbar body 31 and a connection piece 32. The busbar body 31 is a flat plate-shaped member made of a conductor (for example, made of copper) and has an overall rectangular shape. The connection piece 32 protrudes from the busbar body 31 toward the main line 21. The busbar body 31 is provided with two electrode holes 33, 33 through which the positive electrode 4 and the negative electrode 5 of the adjacent single cells 2 pass. The terminal portion 25 provided at the distal end 24 of the branch line 22 is connected to an upper face of the connection piece 32 of the busbar 30. That is, the busbar 30 connected to the terminal portion 25 provided at the distal end 24 of the branch line 22 can move relative to the main line 21 in the longitudinal direction of the main line 21 (that is, the stacking direction of the battery assembly 1) by deforming the branch line 22 around the absorption portion 23.

In a state in which the busbar module 10 having the above configuration is attached to the battery assembly 1, for example, even when a relative position between the battery assembly 1 and the circuit body 20 changes due to deformation of the battery assembly 1, causing a change in a relative position between the main line 21 and the busbar 30 in the stacking direction of the battery assembly 1, the change (deviation) in the relative position can be absorbed by deforming the branch line 22 around the absorption portion 23. Similarly, even when a size of the battery assembly 1 in the stacking direction varies for each manufactured battery assembly 1 due to an assembly tolerance of the plurality of single cells 2, a manufacturing variation can be absorbed by deforming the branch line 22 around the absorption portion 23. Since the branch line 22 has a shape in which the branch line 22 is folded back toward the main line 21 to overlap the main line 21 in the thickness direction of the main line 21, a size of the circuit body 20 in the width direction can be reduced.

### <Operations and Effects>

As described above, according to the busbar module 10 according to the present embodiment, the circuit body 20 formed of the flexible substrate includes the strip-shaped main line 21 and the strip-shaped branch lines 22 branching from the main line 21. At least a part of the branch line 22 includes the absorption portion 23 extending along the stacking direction of the battery assembly 1, and has the shape in which the part of the branch line 22 is folded back toward the main line 21 to overlap the main line 21 in the thickness direction of the main line 21. Therefore, when the battery assembly 1 expands and contracts in the stacking direction due to thermal deformation of each single cell 2, the busbar 30 can move in the stacking direction of the single cells 2 by deforming the branch line 22 around the absorption portion 23 of the branch line 22 of the circuit body 20. Similarly, the variation in the size of the battery assembly 1 in the stacking direction which occurs due to the assembly tolerance of the single cells 2 can be absorbed. In other words, in the busbar module 10 according to the present embodiment, the main line 21 of the circuit body 20 does not need to be deformed at all, and it is possible to easily cope with the expansion and contraction and the manufacturing variation of the battery assembly 1 by substantially deforming only the branch line 22. Since the branch line 22 has the shape in which the branch line 22 is folded back toward the main line 21 to overlap the main line 21 in the thickness direction of the main line 21, the size of the circuit body 20 in the width direction can be reduced. In general, even when the flexible substrate includes a large number of circuit structures, the flexible substrate is easily and flexibly deformed using a much smaller force as compared with an electric wire used in a busbar module in the related art described above. Therefore, assemblability of the busbar module 10 to the battery assembly 1 is significantly improved.

### OTHER EMBODIMENTS

The present disclosure is not limited to the embodiment described above and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiments described above are freely selected and are not limited as long as the present disclosure can be implemented.

For example, in the embodiment described above, as shown in FIG. 2, before being folded back, the branch line 22 extends from the side end of the main line 21 in the area that is outside the side end of the main line 21 in the width direction while being bent so as to have the substantially U-shape that opens toward the main line 21 when viewed from the upper-lower direction. As shown in FIG. 3, the branch line 22 shown in FIG. 2 is folded back to the front side (upper side) of the main line 21 toward the main line 21 such that substantially the entire branch line 22 overlaps the main line 21 in the thickness direction of the main line 21.

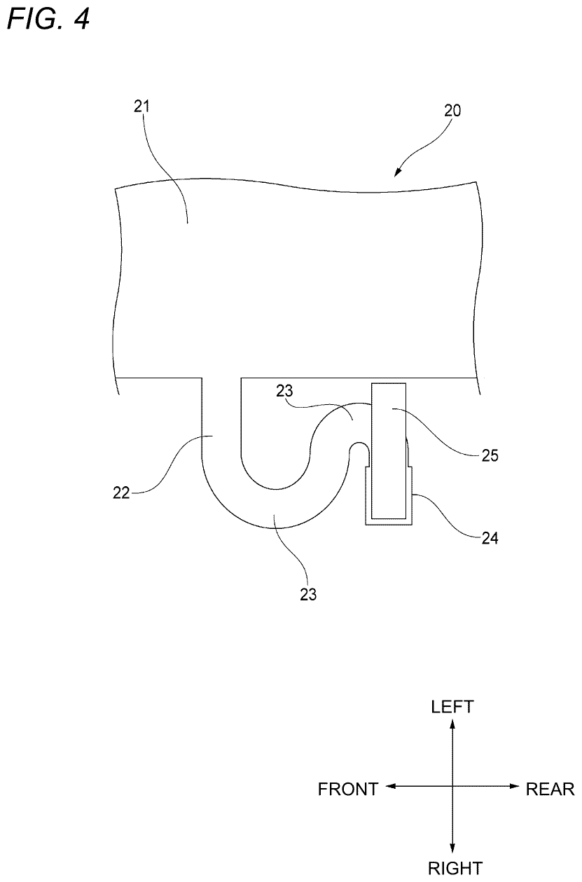

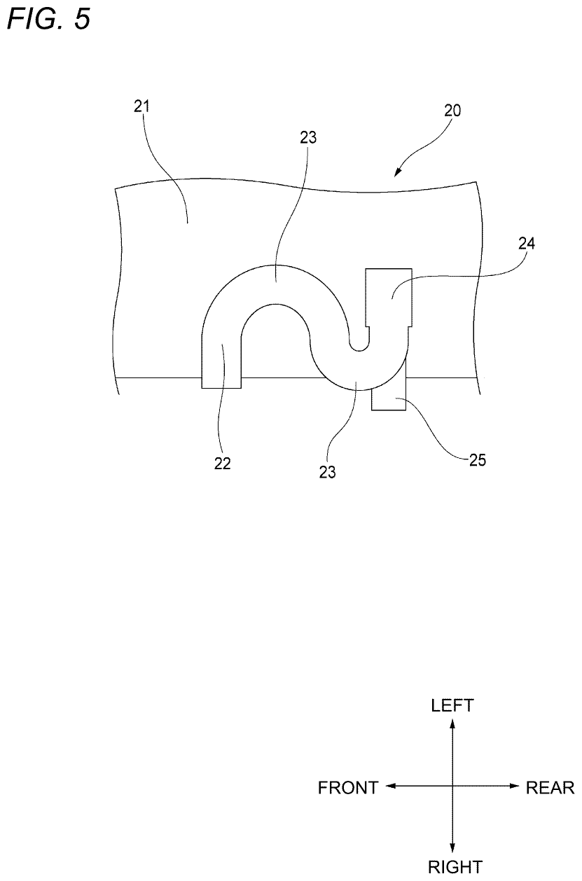

Meanwhile, in a first modification shown in FIGS. 4 and 5, as shown in FIG. 4, before being folded back, the branch line 22 extends in the longitudinal direction of the main line 21 from the side end of the main line 21 in the area that is outside the side end of the main line 21 in the width direction while being bent to have a substantially S-shape when viewed from the upper-lower direction. As shown in FIG. 5, the branch line 22 shown in FIG. 4 is folded back to the front side (upper side) of the main line 21 toward the main line 21 such that substantially the entire branch line 22 overlaps the main line 21 in the thickness direction of the main line 21. As a result, the terminal portion 25 is arranged to protrude outward in the width direction (left-right direction) from the side end of the main line 21. In the first modification, the branch line 22 includes the absorption portion 23 that is a portion extending in the longitudinal direction of the main line 21. In this example, two absorption portions 23 are provided in the branch line 22. Accordingly, the branch line 22 can more efficiently absorb the expansion and contraction of the battery assembly 1 in the stacking direction and the variation in the size of the battery assembly 1 in the stacking direction which occurs due to the assembly tolerance.

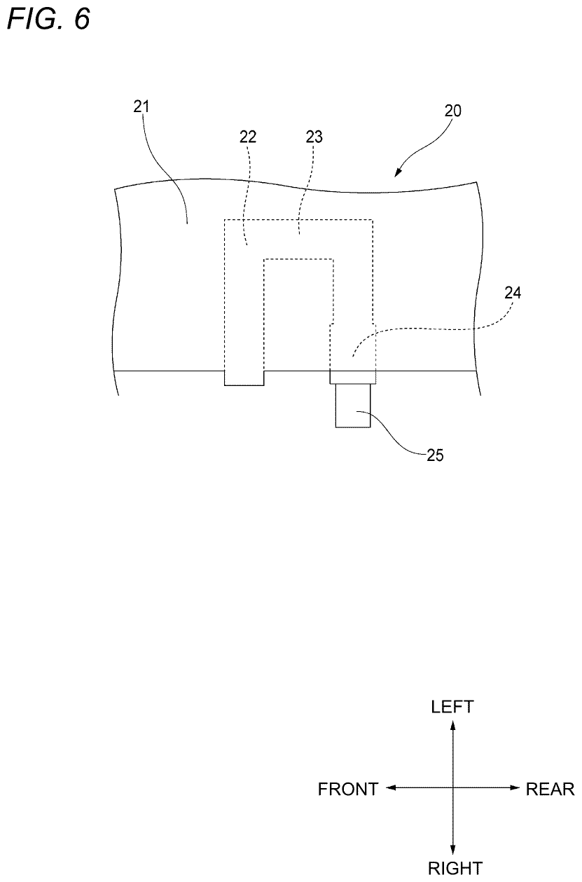

In a second modification shown in FIG. 6, similarly to the embodiment described above, as shown in FIG. 2, before being folded back, the branch line 22 extends from the side end of the main line 21 in the area that is outside the side end of the main line 21 in the width direction while being bent so as to have the substantially U-shape that opens toward the main line 21 when viewed from the upper-lower direction. As shown in FIG. 6, the branch line 22 shown in FIG. 2 is folded back to a back side (lower side) of the main line 21 toward the main line 21 such that substantially the entire branch line 22 overlaps the main line 21 in the thickness direction of the main line 21.

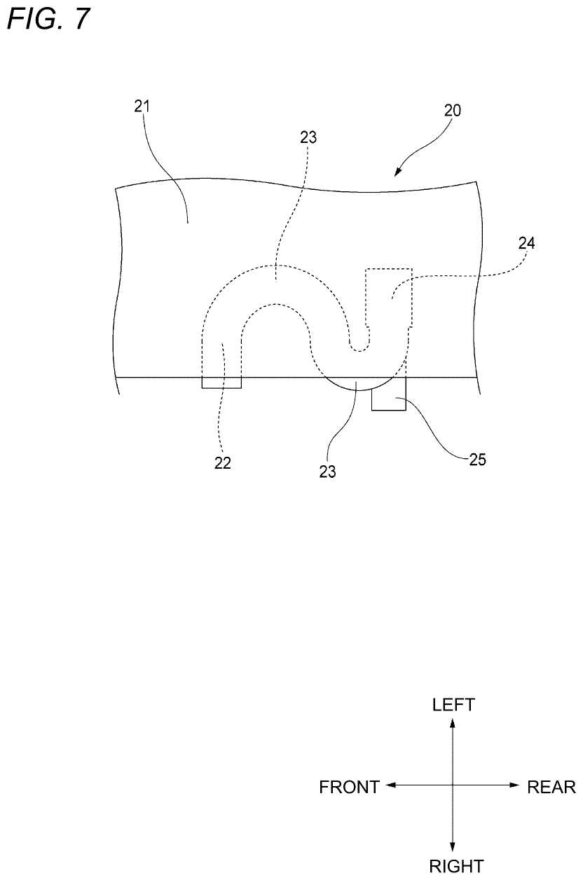

In a third modification shown in FIG. 7, similarly to the first modification, as shown in FIG. 4, before being folded back, the branch line 22 extends in the longitudinal direction of the main line 21 from the side end of the main line 21 in the area that is outside the side end of the main line 21 in the width direction while being bent so as to have the substantially S-shape when viewed from the upper-lower direction. As shown in FIG. 7, the branch line 22 shown in FIG. 4 is folded back to the back side (lower side) of the main line 21 toward the main line 21 such that substantially the entire branch line 22 overlaps the main line 21 in the thickness direction of the main line 21.

Also in the first to third modifications, operations and effects the same as those of the embodiment described above can be achieved.

Here, features of the embodiments described above of the busbar module 10 according to the present disclosure will be briefly summarized and listed in the following first to second aspects.

### <First Aspect>

A busbar module (10) to be attached to a battery assembly (1) in which a plurality of single cells (2) are stacked, the busbar module (10) including:
a circuit body (20) formed of a flexible substrate in which a wiring pattern is provided; and
busbars (30) configured to be respectively connected to electrodes (4,5) of the plurality of single cells (2), in which
the circuit body (20) includes:
a main line (21) configured to be arranged to extend along a stacking direction of the plurality of single cells (2),
a branch line (22) configured to be branched from the main line (21) and to extend toward the busbar (30), the branch line (22) having a portion (23) extending along the stacking direction as at least a part of the branch line (22); and
a terminal portion (25) configured to be provided at a location of the branch line (22) which is closer to a distal end side than the portion (23), and to be attached to the busbar (30), and
the branch line (22) has a shape in which at least a part of the branch line (22) is folded back toward the main line (21) to overlap the main line (21) in a thickness direction of the main line (21).

According to the busbar module having the above configuration, the circuit body formed of the flexible substrate includes the main line and the branch line branching from the main line. At least a part of the branch line has the portion (absorption portion described later) extending along the stacking direction of the single cells. The branch line has the shape in which at least a part of the branch line is folded back toward the main line to overlap the main line in the thickness direction of the main line. Therefore, when the battery assembly expands and contracts in the stacking direction due to thermal deformation of each single cell, the busbar can move in the stacking direction of the single cells by deforming the branch line around the absorption portion of the branch line of the circuit body and the periphery of the absorption portion. Similarly, the variation in the size of the battery assembly in the stacking direction which occurs due to the assembly tolerance of the single cells can be absorbed. In other words, in the busbar module having the configuration, the main line of the circuit body does not need to be deformed at all, and it is possible to easily cope with the expansion and contraction and the manufacturing variation of the battery assembly. by substantially deforming only the branch line. Since the branch line has the shape in which the branch line is folded back toward the main line to overlap the main line in the thickness direction of the main line, the size of the circuit body in the width direction can be reduced as compared with a case in which the branch line simply extends from the main line. In general, even when the flexible substrate includes a large number of circuit structures, the flexible substrate is easily and flexibly deformed using a much smaller force as compared with an electric wire used in the busbar module in the related art described above. Therefore, the busbar module having the configuration has excellent adaptability to the deformation and the manufacturing variation of the battery assembly.

### <Second Aspect>

In the busbar module (10) according to first aspect, in which
the branch line (22) has the portion (23) at a plurality of locations of the branch line (22).

According to the busbar module having the configuration of the above second aspect, the branch line of the circuit body has a plurality of portions described above (that is, the absorption portion). Accordingly, the branch line can more efficiently absorb the expansion and contraction of the battery assembly in the stacking direction which occurs due to the thermal deformation of each single cell and the variation in the size of the battery assembly in the stacking direction which occurs due to the assembly tolerance of the single cells.

What is claimed is:

1. A busbar module to be attached to a battery assembly in which a plurality of single cells are stacked, the busbar module comprising:
a circuit body formed of a flexible substrate in which a wiring pattern is provided; and
busbars configured to be respectively connected to electrodes of the plurality of single cells, wherein the circuit body includes:
a main line configured to be arranged to extend along a stacking direction of the plurality of single cells;
a branch line configured to be branched from the main line and to extend toward the busbar, the branch line having a portion extending along the stacking direction as at least a part of the branch line; and
a terminal portion configured to be provided at a location of the branch line which is closer to a distal end side than the portion, and to be attached to the busbar, and
the branch line has a shape in which at least a part of the branch line is folded back toward the main line to overlap the main line in a thickness direction of the main line.

2. The busbar module according to claim 1, wherein
the branch line has the portion at a plurality of locations of the branch line.
